(19) United States
(12) Patent Application Publication
(10) Pub. No.: US 2026/0053143 A1
(43) Pub. Date: Feb. 26, 2026

(54) AQUEOUS ANTIMICROBIAL COMPOSITION

(71) Applicants: DOW GLOBAL TECHNOLOGIES LLC, Midland, MI (US); ROHM AND HAAS COMPANY, Collegeville, PA (US)

(72) Inventors: Han LIU, Shanghai (CN); Wei CUI, Shanghai (CN); Yingzhou XIAO, Shanghai (CN); Zhijuan GONG, Shanghai (CN); Jianming XU, Shanghai (CN)

(21) Appl. No.: 19/103,080

(22) PCT Filed: Sep. 30, 2022
(86) PCT No.: PCT/CN2022/123007

§ 371 Date: Feb. 11, 2025

(51) Int. Cl. A01N 59/16; A01N 25/02; A01P 1/00; C09D 5/14; C09D 7/61; C09D 133/12

(52) U.S. Cl. CPC A01N 59/16; A01N 25/02; A01P 1/00; C09D 5/14; C09D 7/61; C09D 133/12

(57) ABSTRACT

Discloses an aqueous antimicrobial coating composition comprising: (A) a polymer obtained by a multistage polymerisation and composed of: 75% to 95% of a first-stage polymer and from 5% to 25% of a second-stage polymer; wherein the first-stage polymer comprises: monoethylenically unsaturated functional monomers carrying at least one functional group selected from a carboxyl, carboxylic anhydride, sulfonic acid, amide, sulfonate, phosphoric acid, phosphonate, phosphate, or hydroxyl group (e.g. acrylic acid, acrylamide); <1.0% of a monomers bearing imidazole, benzotriazole, or benzimidazole; and monoethylenically unsaturated nonionic monomers (e.g. alkyl acrylate); wherein the second-stage polymer has MW=8000 to 30000 g/mol and comprises: residues of C6-C24 alkyl thiol (e.g. dodecyl mercaptan); monomers bearing imidazole, benzotriazole, or benzimidazole (e.g. vinyl imidazole); and monomers of alkyl acrylate; wherein the monomers bearing imidazole, benzotriazole, or benzimidazole in a multistage polymer are present at a total concentration of 0.5% to 8%; and (B) 1 to 10000 ppm of a silver, wherein the mol ratio of monomers bearing imidazole, benzotriazole, or benzimidazole to silver is greater than 4; and (C) <500 ppm of coagulum (coagulates having diameter>44 micrometers); and a method of preparing such aqueous antimicrobial composition and a coating composition comprising such aqueous antimicrobial composition and a pigment.

### FIELD

The present invention relates to an aqueous antimicrobial composition and a method of preparing the same.

### INTRODUCTION

Silver ion or silver element is widely used in compositions to provide antimicrobial properties. The higher the silver content is in the compositions, the better the antimicrobial properties. However, aqueous binder and coating compositions containing inorganic microbiocides on which metal ions are supported often undergo conspicuous changes in coloration upon exposure to heat or sun light. Accordingly, the use of these microbiocides is effectively limited to systems for which such changes in coloration can be tolerated. Discoloration issues could be improved by incorporating silver complexed with polymers bearing imidazole pendant groups as antimicrobial additives into polymer binders, which, however, requires the polymer binders have good compatibility with the antimicrobial additives. Recently, some paint manufacturers are seeking solutions for paints that can not only afford antibacterial properties but antiviral properties which usually require even higher silver content, thus making the discoloration issue even worse. Simply increasing the content of imidazole monomers used in preparing polymer binders may be helpful in improving coloration stability of silver-containing antimicrobial compositions comprising such polymer binders, but the polymerization process for preparing such polymer binders tends to be unstable and thus a large amount of coagulum formed during the polymerization process (e.g., more than 500 parts per million (ppm) of coagulum relative to polymer binder weight). It is therefore desirable to provide an aqueous antimicrobial composition with improved coloration stability property upon exposure to heat without compromising process stability for preparing such aqueous antimicrobial composition.

### SUMMARY

The present invention solves the problem of discovering an aqueous antimicrobial composition without the aforementioned problems. The aqueous antimicrobial composition of the present invention comprises a novel combination of a specific multistage polymer bearing specific heterocyclic pendant groups (such as imidazole groups) and a silver, which affords good process stability with less than 500 ppm of coagulum formed in preparation of such antimicrobial composition, by weight based on the weight of the aqueous antimicrobial composition. At the same time, the aqueous antimicrobial composition has improved coloration stability upon exposure to heat, even at a mole ratio of heterocyclic groups in the multistage polymer to the silver of larger than 4:1, as indicated by a coloration stability rating of 3 or higher after exposure at 50 degrees Celsius (° C.) for 10 days (further details provided in the Examples section below). Such antimicrobial composition is particularly suitable for use in coating applications to provide coating films or coated surfaces with antimicrobial properties.

In a first aspect, the present invention is an aqueous antimicrobial composition comprising:
(A) a multistage polymer comprising, by weight based on the weight of the multistage polymer, from 75% to 95% of a first-stage polymer and from 5% to 25% of a second-stage polymer;
wherein the first-stage polymer comprises:
zero to 1.0% of structural units of a monomer containing at least one heterocyclic group selected from imidazole, benzotriazole, and benzimidazole, by weight based on the weight of the first-stage polymer;
structural units of a monoethylenically unsaturated functional monomer carrying at least one functional group selected from a carboxyl, carboxylic anhydride, sulfonic acid, amide, sulfonate, phosphoric acid, phosphonate, phosphate, or hydroxyl group, a salt thereof, or combinations thereof; and
structural units of a monoethylenically unsaturated nonionic monomer;
wherein the second-stage polymer has a molecular weight of 8000 to 30000 grams per mole and residues of an alkyl thiol with a C₆-C₄ alkyl and comprises:
structural units of a monomer containing at least one heterocyclic group selected from imidazole, benzotriazole, and benzimidazole; and
structural units of an alkyl acrylate;
wherein structural units of the monomer containing at least one heterocyclic group in the multistage polymer are present at a total concentration of 0.5% to 8%, by weight based on the weight of the multistage polymer; and
(B) 1 to 10000 parts per million, by weight based on the weight of the multistage polymer, of a silver;
wherein the mole ratio of heterocyclic groups in the multistage polymer to the silver is greater than 4; and
wherein the aqueous antimicrobial composition comprises up to 500 parts per million of coagulum, by weight based on the weight of the aqueous antimicrobial composition.

In a second aspect, the present invention is a method of preparing the aqueous antimicrobial composition of the first aspect. The method comprises: admixing the multistage polymer with the silver; wherein the multistage polymer comprising the first-stage polymer and the second-stage polymer is prepared by a multistage free-radical polymerization process comprising:
(i) forming the first-stage polymer by free-radical polymerization of a first monomer mixture, followed by neutralizing the first-stage polymer to a pH value of greater than 7.5; thereby obtaining the neutralized first-stage polymer; and
(ii) preparing the second-stage polymer by free-radical polymerization of a second monomer mixture in the presence of the neutralized first stage-polymer obtained from step (i) above;
wherein the first monomer mixture comprises, by weight based on the total weight of monomers in the first monomer mixture, zero to 1.0% of a monomer containing at least one heterocyclic group selected from imidazole, benzotriazole, and benzimidazole; a monoethylenically unsaturated functional monomer carrying at least one functional group selected from a carboxyl, carboxylic anhydride, sulfonic acid, amide, sulfonate, phosphoric acid, phosphonate, phosphate, or hydroxyl group, a salt thereof, or combinations thereof; and a monoethylenically unsaturated nonionic monomer;
wherein the second monomer mixture comprises, by weight based on the total weight of monomers in the second monomer mixture, a monomer containing at least one heterocyclic group selected from imidazole, benzotriazole, and benzimidazole; an alkyl acrylate; and an alkyl thiol with a C₆-C₂₄ alkyl; and
wherein the total concentration of the monomer containing at least one heterocyclic group for preparing the multistage polymer is 0.5% to 8%, by weight based on the total weight of monomers in the first and second monomer mixtures.

In a third aspect, the present invention is a coating composition comprising the aqueous antimicrobial composition of the first aspect and a pigment.

### DETAILED DESCRIPTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International methods and JIS refers to Japanese Industrial Standard.

Products identified by their tradename refer to the compositions available under those tradenames on the priority date of this document. “And/of” means “and, or as an alternative”. All ranges include endpoints unless otherwise indicated.

“Antimicrobial composition” refers to a composition which can destroy, or prevent the growth of, microorganisms such as bacteria, fungi, and virus, including, for example, the inhibition of the growth and the killing of bacteria or other microbes in the composition, or on surface of an article coated by the composition.

“Aqueous” composition herein means that polymer particles dispersed in an aqueous medium. By “aqueous medium” herein is meant water and from 0 to 30%, by weight based on the weight of the medium, of water-miscible compound(s) such as, for example, alcohols, glycols, glycol ethers, glycol esters, or mixtures thereof.

“Structural units”, also known as “polymerized units”, of the named monomer, refers to the remnant of the monomer after polymerization, that is, polymerized monomer or the monomer in polymerized form. For example, a structural unit of methyl methacrylate is as illustrated:

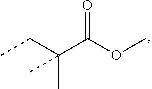

where the dotted lines represent the points of attachment of the structural unit to the polymer backbone.

“Nonionic monomer” herein refers to a monomer that does not bear an ionic charge between pH=1-14.

Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate.

“Glass transition temperature” or “T_{g}” as used herein can be calculated by using a Fox equation (T. G. Fox, Bull. Am. Physics Soc., Volume 1, Issue No. 3, page 123 (1956)) below. For example, for calculating the T_{g} of a copolymer of monomers M₁ and M₂,

$$\frac{1}{{T}_{g} ( calc . )} = \frac{w ( {M}_{1} )}{{T}_{g} ( {M}_{1} )} + \frac{w ( {M}_{2} )}{{T}_{g} ( {M}_{2} )} ,$$

where T_{g}(calc.) is the glass transition temperature calculated for the copolymer, w(M₁) is the weight fraction of monomer M₁ in the copolymer, w(M₂) is the weight fraction of monomer M₂ in the copolymer, T_{g}(M₁) is the glass transition temperature of the homopolymer of monomer M₁, and T_{g}(M₂) is the glass transition temperature of the homopolymer of monomer M₂, all temperatures being in K. The glass transition temperatures of the homopolymers may be found, for example, in “Polymer Handbook”, edited by J. Brandrup and E. H. Immergut, Interscience Publishers.

“Multistage polymer” herein means a polymer prepared by sequential addition of two or more different monomer compositions including the first monomer mixture and the second monomer mixture, which, after polymerization, form a first-stage polymer and a second-stage polymer, respectively. That is, the multistage polymer comprises at least two polymers, i.e., the first-stage polymer and the second-stage polymer. By “first-stage polymer” (interchangeable with “first polymer”) and “second-stage polymer” (interchangeable with “second polymer”) mean these polymers having different compositions and formed in different stages of multistage free-radical polymerization in preparing the multistage polymer. Each stage is sequentially polymerized and different from the immediately proceeding and/or immediately subsequent stage by a difference in monomer composition. By “second-stage polymer” herein is meant a polymer which is formed in the presence of the “first-stage polymer.” However, the first-stage polymer may be formed in the presence of a previously formed dispersed polymer at a concentration of 0 to 10% by weight, based on the weight of the first-stage polymer, sometimes known as a seed polymer, of a composition that is the same as that of the first-stage polymer. When the seed polymer is used, the weight the seed polymer is counted into the first-stage polymer. “Weight of multistage polymer” in the present invention refers to the dry or solids weight of the aqueous dispersion of multistage polymer.

The antimicrobial composition of the present invention comprises a multistage polymer bearing pendant heterocyclic groups selected from imidazole, benzotriazole, and benzimidazole. The pendant heterocyclic groups are derived from a monomer containing at least one heterocyclic group by polymerization. Desirably, the heterocyclic group is an imidazole group.

The multistage polymer comprises a first-stage polymer and a second-stage polymer. The second-stage polymer in the multistage polymer comprises structural units of the monomer containing at least one heterocyclic group selected from an imidazole group, a benzotriazole group, and a benzimidazole group (hereinafter also referred to “heterocyclic monomer”). The heterocyclic monomer useful in the present invention can be an imidazole group-containing monomer, a benzotriazole group-containing monomer, a benzimidazole group-containing monomer, or mixtures thereof. Suitable heterocyclic monomers may include, for example, 1-vinyl imidazole, vinyl benzotriazole, vinyl methyl benzotriazole, vinyl benzothiazole, vinylmethylbenzothiazole, vinyl benzimidazole, vinyl methyl benzimidazole, or mixtures thereof. Desirably, the heterocyclic monomer is 1-vinyl imidazole.

The second-stage polymer in the multistage polymer comprises structural units of the heterocyclic monomer at a concentration of 0.6% to 80%, and can be 0.6% or more, 0.8% or more, 1.0% or more, 1.2% or more, 1.4% or more, 1.6% or more, 1.8% or more, 2% or more, 2.5% or more, 3.0% or more, 3.5% or more, or even 3.75% or more, and at the same time is generally 80% or less, and can be 70% or less, 60% or less, 50% or less, 40% or less, 30% or less, or even 25% or less; and desirably, from 3.0% to 40%, from 5% to 30%, or from 8% to 20%, by weight based on the weight of the second-stage polymer.

The first-stage polymer may comprise or be free of structural units of the heterocyclic monomer. Structural units of the heterocyclic monomer in the first polymer may be present at a concentration of from zero to 1.0%, and can be less than 1.0%, less than 0.8%, less than 0.7%, less than 0.6%, less than 0.5%, less than 0.3%, less than 0.2%, or even less than 0.1%, by weight based on the weight of the first-stage polymer.

Structural units of the heterocyclic monomer in the multistage polymer (e.g., in the second-stage polymer and optionally in the first-stage polymer) are present at a total concentration of 0.5% to 8%, and can be 0.5% or more, 0.6% or more, 0.7% or more, 0.75% or more, 0.8% or more, 0.9% or more, 1.0% or more, 1.2% or more, 1.4% or more, 1.6% or more, or even 2% or more, while at the same time is generally 8% or less, and can be 7% or less, 6% or less, 5% or less, 4% or less, 3% or less, or even 2% or less; and desirably, 0.75% to 5%, 1% to 4%, or 1.5% to 3%, by weight based on the weight of the multistage polymer. Desirably, from 60% to 100% of structural units of the heterocyclic monomer of the multistage polymer are present in the second-stage polymer, and can be 65% or more, 70% or more, 75% or more, 80% or more, 85% or more, 90% or more, 95% or more, or even 100% of structural units of the heterocyclic monomer are present in the second-stage polymer.

The first-stage polymer in the multistage polymer comprises structural units of one or more monoethylenically unsaturated functional monomers carrying at least one functional group selected from a carboxyl, carboxylic anhydride, sulfonic acid, amide, sulfonate, phosphoric acid, phosphonate, phosphate, or hydroxyl group, a salt thereof, or combinations thereof. Examples of suitable monoethylenically unsaturated functional monomers include α,β-ethylenically unsaturated carboxylic acids including an acid-bearing monomer such as methacrylic acid, acrylic acid, itaconic acid, maleic acid, or fumaric acid; or a monomer bearing an acid-forming group which yields or is subsequently convertible to, such an acid group such as anhydride, (meth)acrylic anhydride, or maleic anhydride; sodium styrene sulfonate (SSS), sodium vinyl sulfonate (SVS), 2-acrylamido-2-methylpropanesulfonic acid (AMPS), sodium salt of 2-acrylamido-2-methyl-1-propanesulfonic acid, ammonium salt of 2-acrylamido-2-methyl-1-propane sulfonic acid; sodium salt of allyl ether sulfonate; acrylamide, methacrylamide, monosubstituted (meth)acrylamide, N-methylacrylamide, N-ethylacrylamide, N-isopropylacrylamide, N-butylacrylamide, N-tertiary butylacrylamide, N-2-ethylhexylacrylamide, N,N-dimethylacrylamide, N,N-diethylacrylamide; hydroxy-functional (meth)acrylic acid alkyl ester such as hydroxyethyl methacrylate and hydroxypropyl methacrylate; phosphoalkyl (meth)acrylates such as phosphoethyl (meth)acrylate, phosphopropyl (meth)acrylate, phosphobutyl (meth)acrylate, salts thereof, and mixtures thereof; CH₂═C(Rₚ₁)—C(O)—O—(Rₚ₂O)ₚ—P(O)(OH)₂, wherein Rₚ₁═H or CH₃, Rₚ₂=alkyl and p=1-10, such as SIPOMER PAM-100, SIPOMER PAM-200, and SIPOMER PAM-300 all available from Solvay; phosphoalkoxy (meth)acrylates such as phospho ethylene glycol (meth)acrylate, phospho di-ethylene glycol (meth)acrylate, phospho tri-ethylene glycol (meth)acrylate, phospho propylene glycol (meth)acrylate, phospho di-propylene glycol (meth)acrylate, phospho tri-propylene glycol (meth)acrylate, allyl ether phosphate, vinyl phosphonic acid, salts thereof; or mixtures thereof. Desirably, the monoethylenically unsaturated functional monomer is selected from phosphoethyl methacrylate (PEM), acrylic acid (AA), acrylamide (AM), methacrylic acid (MAA), or mixtures thereof. More desirably, the monoethylenically unsaturated functional monomer is AA, AM, or a mixture of AA and AM.

The first-stage polymer may comprise structural units of the monoethylenically unsaturated functional monomer at a concentration of 0.1% to 15%, and can be 0.1% or more, and can be 0.3% or more, 0.5% or more, 0.8% or more, 0.9% or more, 1.0% or more, 1.1% or more 1.2% or more, 1.5% or more, 1.8% or more, 2.0% or more, 2.1% or more, or even 2.2% or more, while at the same time is generally 15% or less, and can be 12% or less, 10% or less, 8% or less, 5% or less, 3% or less, 3.2% or less, or even 2.8% or less; and desirably, from 0.1% to 10%, from 1.8% to 3.2%, or from 2.2% to 2.8%, by weight based on the weight of the first-stage polymer.

The first-stage polymer of the multistage polymer comprises structural units of a monoethylenically unsaturated nonionic monomer that is other than the monoethylenically unsaturated functional monomer described above. The monoethylenically unsaturated nonionic monomer may be selected from an alkyl acrylate, an alkyl methacrylate, a cycloalkyl (meth)acrylate, a vinyl aromatic monomer, a silane monomer, or mixtures thereof. The alkyl acrylate and alkyl methacrylate refer to an alkyl ester of acrylic acid and an alkyl ester of methacrylic acid, respectively, each containing a linear or branched alkyl typically containing 1 to 12 carbon atoms. The alkyl acrylate and alkyl methacrylate may include a C₁-C₄-alkyl (meth)acrylate, a C₆-C₁₀-alkyl (meth)acrylate, or mixtures thereof. Examples of suitable alkyl acrylates and alkyl methacrylates include methyl acrylate, methyl methacrylate, butyl acrylate, butyl methacrylate, ethyl acrylate, ethyl methacrylate, or mixtures thereof. Suitable cycloalkyl (meth)acrylates may include, for example, cyclohexyl (meth)acrylate, methcyclohexyl (meth)acrylate, dihydrodicyclopentadienyl (meth)acrylate, trimethylcyclohexyl (meth)acrylate, t-butyl cyclohexyl (meth)acrylate, or mixtures thereof. The C₆-C₁₀-alkyl (meth)acrylates refer to alkyl ester of acrylic acid or methacrylic acid containing a linear or branched alkyl with from 6 to 10 carbon atoms, desirably, from 6 to 8 carbon atoms. Examples of suitable C₆-C₁₀-alkyl (meth)acrylates include 2-ethylhexyl acrylate, 2-ethylhexyl methacrylate, or mixtures thereof. Suitable silane monomers may include, for example, alkylvinyldialkoxysilanes; vinyltrialkoxysilanes such as vinyltriethoxysilane and vinyltrimethoxysilane; (meth)acryl functional silanes including, for example, (meth)acryloxyalkyltrialkoxysilanes such as gamma-methacryloxypropyltrimethoxysilane and methacryloxypropyltriethoxysilane; 3-methacryloxypropylmethyldimethoxysilane; 3-methacryloxypropyltrimethoxysilane; 3-methacryloxypropyltriethoxysilane; or mixtures thereof. Desirably, the monoethylenically unsaturated nonionic monomer comprises or consists of one or more C₁-C₄-alkyl (meth)acrylates, one or more C₁-C₄-alkyl acrylates, or mixtures thereof. More desirably, the monoethylenically unsaturated nonionic monomer is selected from methyl acrylate, methyl methacrylate, butyl methacrylate, ethyl methacrylate, butyl acrylate, ethyl acrylate, 2-ethylhexyl acrylate or mixtures thereof. The first-stage polymer may comprise structural units of the monoethylenically unsaturated nonionic monomer (e.g., C₁-C₄-alkyl (meth)acrylate) at a concentration of 85% to 99%, and can be greater than 90%, 91% or more, 92% or more, 93% or more, or even 94% or more, while at the same time is generally 99% or less, and can be 98% or less, 97% or less, or even 96% or less, by weight based on the weight of the first-stage polymer.

Alternatively, when the multistage polymer comprises structural units of the C₆-C₁₀-alkyl (meth)acrylate, the cycloalkyl (meth)acrylates, or mixtures thereof. The total concentration of structural units of these monomers is typically less than 5%, and can be less than 4%, less than 3%, less than 2%, less than 1%, or even zero, by weight based on the weight of the multistage polymer.

The second-stage polymer in the multistage polymer comprises structural units of one or more alkyl acrylates as described in the first-stage polymer section above. Suitable examples of alkyl acrylates for forming the second-stage polymer may include C₁-C₄-alkyl acrylates, C₆-C₁₀-alkyl acrylates, or mixtures thereof. Desirably, the second-stage polymer comprises structural units of the C₁-C₄-alkyl acrylate such as butyl acrylate (BA), ethyl acrylate (EA), or mixtures thereof. The second-stage polymer may comprise structural units of the alkyl acrylate at a concentration of 40% to 99%, and can be 40% or more, 50% or more, 60% or more, or even 70% or more, while at the same time is generally 99% or less, 98% or less, 97% or less, or even 96% or less; and desirably, 50% to 98%, 60% to 97%, or 70% to 96%, by weight based on the weight of the second-stage polymer. Desirably, the second-stage polymer in the multistage polymer comprises or consists of structural units of 1-vinyl imidazole and structural units of the C₁-C₄ alkyl acrylate such as BA, EA, or mixtures thereof. More desirably, the second-stage polymer comprises from 3% to 50% of structural units of 1-vinyl imidazole and from 50% to 97% of structural units of the C₁-C₄ alkyl acrylate such as BA, EA or mixtures thereof, by weight based on the weight of the second-stage polymer.

The second-stage polymer in the multistage polymer may comprise or be free of structural units of the monoethylenically unsaturated functional monomer, which may be in an amount such that structural units of the monoethylenically unsaturated functional monomer in the multistage polymer at a total concentration of 0.1% to 10%, and can be 0.1% or more, 0.3% or more, 0.5% or more, 0.8% or more, 0.9% or more, 1.0% or more, 1.1% or more 1.2% or more, or even 1.5% or more, while at the same time is generally 10% or less, and can be 8% or less, 6% or less, 5% or less, 4.5% or less, 4% or less, 3.5% or less, 3% or less, or even 2.8% or less, by weight based on the weight of the multistage polymer.

The second-stage polymer in the multistage polymer may comprise or be free of structural units of an additional monoethylenically unsaturated nonionic monomer that is other than the alkyl acrylate described above.

The additional monoethylenically unsaturated nonionic monomer used for preparing the second-stage polymer may include those described above in the first-stage polymer section, including the alkyl methacrylates such as the C₁-C₄-alkyl methacrylates described above. The second-stage polymer may comprise structural units of the monoethylenically unsaturated nonionic monomer at a concentration of from zero to 20%, and can be 15% or less, 10% or less, 5% or less, 1% or less, or even 0.5% or less, by weight based on the weight of the second-stage polymer.

The second-stage polymer in the multistage polymer also comprises residues of an alkyl thiol that contains a linear or branched alkyl group. “Residues” refers to the remnant of the alkyl thiol after polymerization by the removal of one hydrogen atom from the thiol group. For example, residues of n-dodecyl mercaptan can be as illutrated:

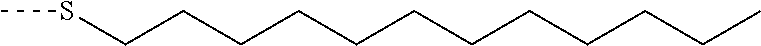

where the dotted lines represent the points of attachment of the residues to the polymer backbone.

The alkyl thiol useful in the present invention may have the structure of R′—SH, wherein R′ is a C₆-C₄ alkyl group, which is unsubstituted or substituted. R′ can be an alkyl having carbon atoms in a range of from 6 to 24, from 7 to 20, from 8 to 18, from 9 to 16, from 10 to 14, or from 11 to 12, which is optionally substituted by R″O—, R″CO—, R″COO—, R″CONH—, where each R″ is independently an alkyl, typically having 1 to 12 carbon atoms, 1 to 10 carbon atoms, 1 to 8 carbon atoms, 1 to 6 carbon atoms or 1 to 2 carbon atoms. Suitable alkyl thiols may include, for example, n-dodecyl mercaptan (nDDM), cetyl mercaptan, octyl mercaptan, hexanethiol, decanethiol, or mixtures thereof.

The second-stage polymer may have a molecular weight of 8000 to 30000 grams per mole (g/mol), and can be 9000 g/mol or more, 9500 g/mol or more, 10000 g/mol or more, 10500 g/mol or more, 11000 g/mol or more, or even 11500 g/mol or more, while at the same time is generally 30000 g/mol or less, and can be 29000 g/mol or less, 28000 g/mol or less, 27500 g/mol or less, 27000 g/mol or less, or even 26500 g/mol or less. Desirably, the second-stage polymer has a molecular weight in a range of 10500 to 27500 g/mol, 11000 to 27000 g/mol, or 11500 to 26500 g/mol. Molecular weight in the present application refers to the number average molecular weight (Mn) of a polymer as calculated by the following equation:

$$Mn = ( {W}_{CTA +} {W}_{Monomer} ) / ( {W}_{CTA} / {M}_{CTA} )$$

where W_{CTA} is the weight of the chain transfer agent, M_{CTA} is the molecular weight of the chain transfer agent, and W_{Monomer} is the total weight of monomers used for preparing the polymer. If no chain transfer agent is used, the calculated Mn of the polymer is taken as 1,000,000 g/mol.

The first-stage polymer in the multistage polymer may comprise structural units of the monoethylenically unsaturated functional monomer such as AA, AM or mixtures thereof, and structural units of the alkyl (meth)acrylate such as C₁-C₄ alkyl (meth)acrylate. Desirably, the first-stage polymer in the multistage polymer comprises or consists of, from zero to 0.65% of structural units of 1-vinyl imidazole, from 0.5% to 10% structural units of the monoethylenically unsaturated functional monomer, and from 90% to 99.5% of structural units of the C₁-C₄ alkyl (meth)acrylate, by weight based on the weight of the first-stage polymer; more desirably, the first-stage polymer is free of structural units of 1-vinyl imidazole.

Desirably, the second-stage polymer in the multistage polymer comprises or consists of from 3% to 50% of structural units of 1-vinyl imidazole and from 50% to 97% of structural units of butyl acrylate, ethyl acrylate, or mixtures thereof, by weight based on the weight of the second-stage polymer.

The multistage polymer of the present invention may comprise structural units of one or more multiethylenically unsaturated monomers, which may be present in the first-stage polymer, the second-stage polymer, or combinations thereof, desirably in the first-stage polymer. Suitable multiethylenically unsaturated monomers may include, for example, butadiene, allyl (meth)acrylate, divinyl benzene, ethylene glycol dimethacrylate, butylene glycol dimethacrylate, or mixtures thereof. The multistage polymer may comprise, by weight based on the weight of the multistage polymer, from zero to 3.0%, from 0.05% to 0.8%, or from 0.1% to 0.5% of structural units of the multiethylenically unsaturated monomers.

The first-stage polymer is present in the multistage polymer at a concentration of 73% or more, and can be 74% or more, 75% or more, 76% or more, 77% or more, 78% or more 79% or more, 80% or more, 82% or more, 85% or more, 88% or more, or even 90% or more, while at the same time is generally 97% or less, and can be 96% or less, 95% or less, 94% or less, 93% or less, 92% or less, 90% or less, 88% or less, 85% or less, 82% or less, or even 80% or less, by weight based on the weight of the multistage polymer. The second-stage polymer is present in the multistage polymer at a concentration of 3% or more, and can be 4% or more, 5% or more, 6% or more, 7% or more, 8% or more, 9% or more, 10% or more, 12% or more, 15% or more, 18% or more, or even 20% or more, while at the same time is generally 27% or less, and can be 26% or less, 25% or less, 24% or less, 23% or less, 22% or less, 20% or less, 18% or less, 15% or less, 12% or less, or even 10% or less, by weight based on the weight of the multistage polymer. Desirably, the multistage polymer comprises 80% to 95% of the first-stage polymer and 5% to 20% of the second-stage polymer, and more desirably, 82% to 93% of the first-stage polymer and 7% to 18% of the second-stage polymer.

The multistage polymer may comprise or be free of a minor amount of a third-stage polymer that can be formed after the second-stage polymer, for example, less than 10% by weight of the multistage polymer, without compromising the desired properties. Desirably, the total amount of the first-stage polymer and the second-stage polymer is from 90% to 100% of the multistage polymer, from 92% to 100%, from 95% to 100%, from 98% to 100%, or from 99% to 100%, by weight based on the weight of the multistage polymer. Total concentration of the structural units of monomers described above in the multistage polymer is equal to 100%, by weight based on the weight of the multistage polymer. Total concentration of the structural units of monomers described above in the first- and second-stage polymer, respectively, is equal to 100%, by weight based on the weight of the first- and second-stage polymer, respectively.

Types and levels of the monomers described above may be chosen to provide the multistage polymer with a Tg suitable for different applications, for example, in the range of from −30 to 50° C., and can be greater than −30° C., −20° C. or more, −16° C. or more, −10° C. or more, −5° C. or more, or even greater than 0° C., while at the same time is generally 50° C. or less, and can be 40° C. or less, 30° C. or less, 25° C. or less, 20° C. or less, or even 15° C. or less. Tg values herein can be calculated by the Fox equation.

Without being bounded by a theory, the multistage polymer may comprise multiple different phases (layers or domains) formed by at least the first-stage polymer and the second-stage polymer. Suitable morphologies for the multistage polymer particles may include core-shell polymer particles in which one polymer phase forms a shell that fully encapsulates a core formed from the other polymer phase; and acorn-type polymer particles in which one polymer phase forms a shell that does not fully encapsulate a core formed from the other polymer phase. The core may be the first-stage polymer phase with the shell formed from the second-stage polymer phase.

The multistage polymer of the present invention may have a particle size of from 50 nanometers (nm) to 500 nm, and can be 50 nm or more, 60 nm or more, 100 nm or more, greater than 100 nm, 105 nm or more, while at the same time is generally 500 nm or less, and can be 300 nm, 200 nm or less, 190 nm or less, or even 180 nm or less. The particle size refers to the number average particle size as measured by a Brookhaven BI-90 Plus Particle Size Analyzer.

The antimicrobial composition may comprise the multistage polymer at a concentration of from 10% to 90%, from 20% to 80%, or from 30% to 60%, by weight based on the dry weight of the antimicrobial composition.

The aqueous antimicrobial composition of the present invention also comprises a silver. The silver typically forms a silver complexed with the multistage polymer. The term “silver complexed with polymer” herein refers to a silver which is complexed with a copolymer via coordination bonds, ion bonds or other weak interactions. The term “silver” refers to a silver ion, a nano-silver, or a compound which can release silver ions when it is incorporated into the antimicrobial composition of the present invention. Silver included in the antimicrobial composition can be in oxidation state silver ion Ag¹⁺ or Ag²⁺. Silver may be added to the antibacterial composition in the form of a silver solution such as silver nitrate in deionized water (“DI”). Aside from DI, other liquid mediums can also be used in the silver solution, such as water, aqueous buffered solutions and organic solutions such as polyethers or alcohols. Other sources of silver for forming silver solutions include silver acetate, silver citrate, silver iodide, silver lactate, silver picrate, silver sulfate, Tollens' Reagent, or mixtures thereof. The concentration of silver in these solutions can vary from the concentration required to add a known quantity of silver to the antibacterial composition to a saturated silver solution.

The antimicrobial composition of the present invention may comprise from 1 part per million (ppm) to 10000 ppm, and can be 5 ppm or more, 10 ppm or more, 15 ppm or more, 20 ppm or more, 25 ppm or more, 50 ppm or more, 100 ppm or more, 200 ppm or more, 300 ppm or more, 400 ppm or more, 500 ppm or more, 600 ppm or more, 700 ppm or more, 800 ppm or more, 1000 ppm or more, or even 1200 ppm or more, while at the same time is generally 10000 ppm or less, and can be 9000 ppm or less, 8000 ppm or less, 7000 ppm or less, 6000 ppm or less, 5000 ppm or less, or even 4500 ppm or less; and desirably, from 200 to 7000 ppm or from 400 to 6000 ppm, of the silver, by weight based on the weight of multistage polymer in the antimicrobial composition. Alternatively, the silver can be in an amount sufficient to provide a mole ratio of heterocyclic groups (such as imidazole groups) in the multistage polymer to the silver is greater than 4:1, and can be 50:1 to 4.5:1, 48:1 to 4.8:1, 45:1 to 5:1, 40:1 to 6:1, 35:1 to 7:1, 25:1 to 9:1, or 25:1 to 15:1. Desirably, 35:1 to 5:1 or 25:1 to 9:1.

The antimicrobial composition of the present invention may comprise or be free of a pyrithione, a pyrithione metal complex, or mixtures thereof. Suitable pyrithione metal complexes may include sodium pyrithione, zinc pyrithione, or mixtures thereof. The pyrithione and the pyrithione metal complex may be present at a concentration of 0.01% to 1.5%, 0.05% to 1.4%, 0.1% to 1.3%, or 0.15% to 1.2%, by dry weight based on the weight of the antimicrobial composition.

The aqueous antimicrobial composition of the present invention may also comprise water. Water may be present, by weight based on the weight of the aqueous dispersion, from 30% to 90% or from 40% to 80%.

The present invention also relates to a method of preparing the aqueous antimicrobial composition. The method comprises admixing the multistage polymer with the silver, and optionally the pyrithione and/or the pyrithione metal complex. The multistage polymer can be prepared by multistage free-radical polymerization that comprises at least two stages—a stage of forming the first-stage polymer and a stage of forming the second-stage polymer in the presence of the first-stage polymer, thereby forming the multistage polymer comprising at least the first-stage polymer and the second-stage polymer. Optionally, different stages can be formed in different reactors. Each of the stages is sequentially polymerized and different from the immediately preceding and/or immediately subsequent stage by a difference in monomer compositions.

The multistage free-radical polymerization process for preparing the multistage polymer may include: (i) forming the first-stage polymer by polymerization of a first monomer mixture, preferably in an aqueous medium, and neutralizing to a pH value of greater than 7.5; thereby obtaining the neutralized first-stage polymer, and (ii) forming the second-stage polymer by polymerization of a second monomer mixture in the presence of the neutralized first-stage polymer. Each stage of the free-radical polymerization can be conducted by polymerization techniques well known in the art such as suspension polymerization or emulsion polymerization of monomers such as the first and second monomer mixtures. Emulsion polymerization is a preferred process. The first and second monomer mixtures may each independently comprise the monomers described above for forming the structural units of the first-stage polymer and the second-stage polymer, respectively. For example, the first monomer mixture may comprise, by weight based on the total weight of monomers in the first monomer mixture, zero to 1.0% of the monomer containing at least one heterocyclic group; the monoethylenically unsaturated functional monomer, and the monoethylenically unsaturated nonionic monomer; and the second monomer mixture may comprise, by weight based on the total weight of monomers in the second monomer mixture, the monomer containing at least one heterocyclic group, the alkyl acrylate, and the alkyl thiol; and the total concentration of the monomer containing at least one heterocyclic group for preparing the multistage polymer is 0.5% to 8%, by weight based on the total weight of monomers in the first and second monomer mixtures. For each monomer, the weight concentration of such monomer relative to the total weight of monomers used in preparing a polymer (e.g., the first-stage polymer) is the same as the above described weight concentration of structural units of such monomer in such polymer (e.g., the first-stage polymer) as described above. For example, the weight concentration of each monomer in the first monomer mixture relative to the total weight of monomers in the first monomer mixture is the same as the weight concentration of structural units of such monomer in the first-stage polymer relative to the weight of the first-stage polymer. Total weight concentration of the monomers in the first monomer mixture for preparing the first-stage polymer is equal to 100% relative to the total weight of monomers in the first monomer mixture. Total weight concentration of the monomers in the second monomer mixture is equal to 100% relative to the total weight of monomers in the second monomer mixture. The first and second monomer mixtures for preparing the first-stage polymer and the second-stage polymer, respectively, may be added neat or as an emulsion in water; or added in one or more addition or continuously, linearly or nonlinearly, over the reaction period of preparing the first-stage polymer, the second-stage polymer, respectively, or combinations thereof. Temperature suitable for emulsion polymerization processes may be lower than 100° C., in a range of from 30 to 95° C., or in a range of from 50 to 90° C.

Neutralization of the first-stage polymer may be conducted prior to the preparation of the second-stage polymer, which is useful to reduce coagulum formed in the multistage free-radical polymerization process. The first-stage polymer may be neutralized to a pH value of greater than 7.5, and can be 7.6 or more, 7.7 or more, 7.8 or more, 7.9 or more, 8.0 or more, 8.1 or more, 8.2 or more, 8.3 or more, 8.4 or more, or even 8.5 or more, while at the same time is generally neutralized to a pH value of 10 or less, and can be 9.8 or less, 9.6 or less, 9.5 or less, 9.4 or less, 9.2 or less, or even 9.0 or less. Neutralization may be conducted by adding one or more base which may lead to partial or complete neutralization of the ionic or latently ionic groups of the first-stage polymer. Examples of suitable bases include ammonia; alkali metal or alkaline earth metal compounds such as sodium hydroxide, potassium hydroxide, calcium hydroxide, zinc oxide, magnesium oxide, sodium carbonate, or aluminum hydroxide; organic amines including, for example, primary, secondary, and tertiary amines, such as triethyl amine, ethylamine, propylamine, monoisopropylamine, monobutylamine, hexylamine, ethanolamine, diethyl amine, dimethyl amine, di-n-propylamine, tributylamine, triethanolamine, dimethoxyethylamine, 2-ethoxyethylamine, 3-ethoxypropylamine, dimethylethanolamine, diisopropanolamine, morpholine, ethylenediamine, 2-diethylaminoethylamine, 2,3-diaminopropane, 1,2-propylenediamine, neopentanediamine, dimethylaminopropylamine, hexamethylenediamine, 4,9-dioxadodecane-1,12-diamine, or 2-amino-2-methyl-1-propanol; or mixtures thereof. Desirably, the base is selected from ammonia, 2-amino-2-methyl-1-propanol, or mixtures thereof.

In the multistage free-radical polymerization process, a free radical initiator may be used in each stage.

The polymerization process may be thermally initiated or redox initiated emulsion polymerization. Examples of suitable free radical initiators include hydrogen peroxide, t-butyl hydroperoxide, cumene hydroperoxide, ammonium persulfate, alkali metal persulfates such as sodium persulfate, sodium perborate, perphosphoric acid, and salts thereof; potassium permanganate, and ammonium or alkali metal salts of peroxydisulfuric acid, or mixtures thereof. Desirably, the free radical initiator is ammonium persulfate, sodium persulfate, or mixtures thereof. Desirably, the free radical initiator is free of an azo compound such as 2,2′-azobis(isobutyronitrile) (AIBN). The free radical initiators may be used typically at a level of 0.01 to 3.0% by weight, based on the total weight of monomers used for preparing the multistage polymer. Redox systems comprising the above described initiators coupled with a suitable reductant may be used in the polymerization process. Examples of suitable reductants include sodium sulfoxylate formaldehyde, ascorbic acid, isoascorbic acid, alkali metal and ammonium salts of sulfur-containing acids, such as sodium sulfite, bisulfite, thiosulfate, hydrosulfite, sulfide, hydrosulfide or dithionite, formadinesulfinic acid, acetone bisulfite, glycolic acid, hydroxymethanesulfonic acid, glyoxylic acid hydrate, lactic acid, glyceric acid, malic acid, tartaric acid and salts of the preceding acids. Chelating agents for the metals may optionally be used.

In the multistage free-radical polymerization process, a surfactant may be used in one or more stage of the multistage free-radical polymerization process. The surfactant may be added prior to or during the polymerization of the monomers, or combinations thereof. A portion of the surfactant can also be added after the polymerization. These surfactants may include anionic and/or nonionic surfactants. Examples of suitable surfactants include alkali metal or ammonium salts of alkyl, aryl, or alkylaryl sulfates, sulfonates or phosphates; alkyl sulfonic acids; sulfosuccinate salts; fatty acids; ethylenically unsaturated surfactant monomers; and ethoxylated alcohols or phenols. The surfactant may be used in an amount of from 0.1% to 5%, from 0.15% to 4%, from 0.2% to 3%, or from 0.2% to 2%, by weight based on the total weight of monomers used for preparing the multistage polymer.

In the multistage free-radical polymerization process, the alkyl thiol is used in preparation of the second-stage polymer, e.g., in the second stage of the multistage free-radical polymerization process. The alkyl thiol is present in the second monomer mixture in a sufficient amount to control the molecular weight of the second-stage polymer described above. Typically, the alkyl thiol may be present in the second monomer mixture at a concentration of 0.5% to 5%, and can be 0.5% or more, 0.75% or more, 0.85% or more, or even 1.0% or more, while at the same time is generally 5% or less, and can be 5% or less, 4% or less, 3% or less, 2% or less, 1.7% or less, 1.6% or less, 1.5% or less, 1.4% or less, or even 1.3% or less, by weight based on the total weight of monomers in the second monomer mixture. The alkyl thiol may be present or absent in preparation of the first-stage polymer. The alkyl thiol may be in the first monomer mixture at a concentration of zero or more, while at the same time is generally 5% or less, 4% or less, 3% or less, 2% or less, 1.7% or less, 1.5% or less, 1% or less, 0.5% or less, 0.2% or less, less than 0.15%, 0.1% or less, less than 0.08%, or even zero or less, by weight based on the total weight of monomers in the first monomer mixture. Desirably, the first monomer mixture for preparing the first-stage polymer is free of an alkyl thiol.

The obtained aqueous dispersion comprising the multistage polymer may be neutralized by adding one or more base to a pH value of 7.5 or more, for example, from 7.7 to 10, from 7.9 to 9.8, from 8.0 to 9.5, or 8.5 to 9.2 (i.e., neutralization after polymerization, also as “post-neutralization step”). Examples of suitable bases include those described above used in the neutralization of the first-stage polymer. Desirably, the multistage polymerization process is free of the post-neuralization step.

The method for preparing the aqueous antimicrobial composition can reduce coagulum formation in the multistage free-radical polymerization process, for example, the dry coagulum content of the resulting aqueous antimicrobial composition can be 500 parts per million (ppm) or less.

The aqueous antimicrobial composition of the present invention can have a reduced coagulum content, such as 500 ppm or less, and can be less than 500 ppm, and can be 450 ppm or less, 400 ppm or less, 350 ppm or less, 300 ppm or less, 250 ppm or less, 200 ppm or less, 150 ppm or less, 100 ppm or less, or even 50 ppm or less, of coagulum, after sieving with 325 mesh (44 micrometers), by weight based on the weight of the aqueous antimicrobial composition (further details provided below under Coagulum Content test). At the same time, the antimicrobial composition also demonstrates improved coloration stability upon exposure to heat, even at a mole ratio of heterocyclic groups (such as imidazole groups) in the multistage polymer to the silver of larger than 4:1. “Improved coloration stability” refers to a coloration stability rating of 3 or higher or 4 or higher, after exposure at 50° C. for 10 days (further details provided in the Examples section below). Such antimicrobial composition is particularly suitable for use in coating applications where require the coloration stability and provide coating films or coated surfaces with antimicrobial properties. The antimicrobial composition of the present invention can provide a coating obtained therefrom (that is, a film obtained after drying, or allowing to dry, the antimicrobial composition applied to a substrate) and the coated substrate with desired antimicrobial properties, as indicated by antibacterial activity of higher than 2.0 (>2.0), according to the Antibacterial Activity Test described in the Examples section below.

The present invention also relates to a coating composition comprising the aqueous antimicrobial composition described above and a pigment. “Pigment” herein refers to a particulate inorganic material which is capable of materially contributing to the opacity or hiding capability of a coating. Such materials typically have a refractive index greater than 1.8. The pigments may include, for example, titanium dioxide (TiO₂), zinc oxide, iron oxide, zinc sulfide, barium sulfate, barium carbonate, or mixtures thereof. Desirably, the pigment is TiO₂. TiO₂ typically exists in two crystal forms, anastase and rutile. TiO₂ may be also available in concentrated dispersion form. The antimicrobial composition may also comprise one or more extenders. “Extender” herein refers to a particulate material having a refractive index of less than or equal to 1.8 and greater than 1.3. Examples of suitable extenders include calcium carbonate, clay, calcium sulfate, aluminosilicates, silicates, zeolites, mica, diatomaceous earth, solid or hollow glass, ceramic beads, nepheline syenite, feldspar, diatomaceous earth, calcined diatomaceous earth, talc (hydrated magnesium silicate), silica, alumina, kaolin, pyrophyllite, perlite, baryte, wollastonite, opaque polymers such as ROPAQUE™ Ultra E available from The Dow Chemical Company (ROPAQUE is a trademark of The Dow Chemical Company), or mixtures thereof. The antimicrobial composition may have a pigment volume concentration (PVC) of from zero to 90%, 10% to 80%, from 20% to 70%, or from 30% to 60%. PVC may be determined by the equation:

$$PVC = [ {Volume}_{( Pigment + Extender )} / {Volume}_{( Pigment + Extender + Binder )} ] \times 100 \% .$$

The coating composition of the present invention may comprise or be free of one or more defoamers. “Defoamers” herein refer to chemical additives that reduce and hinder the formation of foam. Defoamers may be silicone-based defoamers, mineral oil-based defoamers, ethylene oxide/propylene oxide-based defoamers, alkyl polyacrylates, or mixtures thereof. Suitable commercially available defoamers include, for example, TEGO Airex 902 W and TEGO Foamex 1488 polyether siloxane copolymer emulsions both available from TEGO, BYK-024 silicone deformer available from BYK, or mixtures thereof. The defoamer may be present at a concentration of from zero to 1.0%, from 0.1% to 0.6%, or from 0.2% to 0.4%, by weight based on the total dry weight of the coating composition.

The coating composition of the present invention may comprise or be free of one or more thickeners. The thickeners may include polyvinyl alcohol (PVA), clay materials, acid derivatives, acid copolymers, urethane associate thickeners (UAT), polyether urea polyurethanes (PEUPU), polyether polyurethanes (PEPU), or mixtures thereof. Examples of suitable thickeners include alkali swellable emulsions (ASE) such as sodium or ammonium neutralized acrylic acid polymers; hydrophobically modified alkali swellable emulsions (HASE) such as hydrophobically modified acrylic acid copolymers; associative thickeners such as hydrophobically modified ethoxylated urethanes (HEUR); and cellulosic thickeners such as methyl cellulose ethers, hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, and 2-hydoxypropyl cellulose. Desirably, the thickener is a hydrophobically-modified hydroxy ethyl cellulose (HMHEC). The thickener may be present at a concentration of from zero to 5.0%, from 0.2% to 4.0%, or from 0.3% to 3%, by dry weight based on the total dry weight of the coating composition.

The coating composition of the present invention may comprise or be free of one or more wetting agents. “Wetting agents” herein refer to chemical additives that reduce the surface tension of a coating composition, causing the coating composition to more easily spread across or penetrate the surface of a substrate. Wetting agents may be polycarboxylates, anionic, zwitterionic, or non-ionic. The wetting agent may be present at a concentration of from zero to 5.0%, from 0.2% to 4.0%, or from 0.3% to 3.0%, by weight based on the total dry weight of the coating composition.

The coating composition of the present invention may comprise or be free of one or more dispersants. The dispersants may include nonionic, anionic, or cationic dispersants such as polyacids with suitable molecular weight, 2-amino-2-methyl-1-propanol (AMP), dimethyl amino ethanol (DMAE), potassium tripolyphosphate (KTPP), trisodium polyphosphate (TSPP), citric acid and other carboxylic acids. The polyacids used may include homopolymers and copolymers based on polycarboxylic acids (e.g., weight average molecular weight ranging from 1,000 to less than 50,000 as measured by gel permeation chromatography (GPC)), including those that have been hydrophobically- or hydrophilically-modified, e.g., polyacrylic acid or polymethacrylic acid or maleic anhydride with various monomers such as styrene, acrylate or methacrylate esters, diisobutylene, and other hydrophilic or hydrophobic comonomers; salts of thereof; or mixtures thereof. The dispersant may be present at a concentration of from zero to 10%, from 0.2% to 5.0%, or from 0.5% to 3.0%, by dry weight based on the total dry weight of the coating composition.

The coating composition of the present invention may comprise or be free one or more coalescents. “Coalescents” herein refer to slow-evaporating solvents that fuse polymer particles into a continuous film under ambient condition. Examples of suitable coalescents include 2-n-butoxyethanol, dipropylene glycol n-butyl ether, propylene glycol n-butyl ether, dipropylene glycol methyl ether, propylene glycol methyl ether, propylene glycol n-propyl ether, diethylene glycol monobutyl ether, ethylene glycol monobutyl ether, ethylene glycol monohexyl ether, triethylene glycol monobutyl ether, dipropylene glycol n-propyl ether, n-butyl ether, or mixtures thereof.

Preferred coalescents include dipropylene glycol n-butyl ether, ethylene glycol monobutyl ether, diethylene glycol monobutyl ether, n-butyl ether, or mixtures thereof. The coalescent may be present at a concentration of from zero to 35%, from 5% to 30%, or from 10% to 25%, by weight based on the weight of the multistage polymer.

In addition to the components described above, the coating composition of the present invention may further comprise any one or combination of the following additives: buffers, anti-freezing agents, humectants, mildewcides, biocides, anti-skinning agents, colorants, flowing agents, antioxidants, plasticizers, leveling agents, thixotropic agents, adhesion promoters, and grind vehicles. These additives may be present in a combined amount of from zero to 20%, from 0.5% to 15%, or from 1.0% to 10%, by weight based on the dry weight of coating composition.

The coating composition of the present invention may be prepared by admixing the aqueous antimicrobial composition with the pigment, and other optional components as described above. Components in the coating composition may be mixed in any order to provide the antimicrobial composition of the present invention. Any of the above-mentioned optional components may also be added to the composition during or prior to the mixing to form the antimicrobial composition. When the antimicrobial composition comprises the pigment and/or extender, that is, a pigment formulation, the pigments and/or extenders are preferably mixed with the aqueous polymer dispersion as a dispersant to form a slurry of pigments and/or extender. The obtained admixture may be then subjected to shearing in a grinding or milling device as is well known in the pigment dispersion art. Such grinding or milling devices include roller mills, ball mills, bead mills, attrittor mills and include mills in which the admixture is continuously recirculated. The shearing of the admixture is continued for a time sufficient to disperse the pigment. The time sufficient to disperse the pigment typically depends on the nature of the pigment and the aqueous polymer dispersion as a dispersant and the grinding or milling device which is used and will be determined by the skilled practitioner.

The present invention also provides a method of preparing an antimicrobial coating or a coated substrate. The method may comprise: providing the antimicrobial composition or the coating composition, applying the antimicrobial or coating composition to a substrate, and drying, or allowing to dry, the applied antimicrobial or coating composition to form the coating. The antimicrobial composition can be applied to a substrate by incumbent means including brushing, dipping, rolling and spraying. The antimicrobial or coating composition is preferably applied by spraying. The standard spray techniques and equipment for spraying such as air-atomized spray, air spray, airless spray, high volume low pressure spray, and electrostatic spray such as electrostatic bell application, and either manual or automatic methods can be used. After the antimicrobial or coating composition has been applied to a substrate, the antimicrobial or coating composition can dry, or allow to dry, to form a film (this is, coating) at room temperature (20-25° C.), or at an elevated temperature, for example, from 35 to 60° C.

The coating composition of the present invention can be applied to, and adhered to, various substrates. Examples of suitable substrates include concrete, cementious substrates, wood, metals, stones, elastomeric substrates, glass or fabrics, and preferably, wood. The antimicrobial composition can be used as is suitable for various applications where antimicrobial properties such as anti-viral properties are desired, including, for example, wood coatings, metal protective coatings, architecture coatings, traffic paints, marine and protective coatings, automotive coatings, wood coatings, joinery coatings, floor coatings, coil coatings, traffic paints, and civil engineering coatings. The coating composition can be used alone, or in combination with other coatings to form multi-layer coatings.

### EXAMPLES

Some embodiments of the invention will now be described in the following Examples, wherein all parts and percentages are weight percentages unless otherwise specified. The materials used in the examples and their abbreviations are given as below.

Butyl acrylate (BA), methyl methacrylate (MMA), ethyl acrylate (EA), and acrylic acid (AA) are all available from Shanghai LangYuan Chemical Co., Ltd.

n-Dodecyl mercaptan (n-DDM), 1-Hexanethiol, 1-Octanethiol, 1-Butanethiol, Methyl 3-mercaptopropionate (MIP), and butyl 3-mercaptopropionate (BMP), all available from Shanghai Chemical Reagent Co., Ltd., are used as chain transfer agents.

DISPONIL FES 32 (FES-32), available from BASF, is a sodium salt of fatty alcohol ether sulphate and used as a surfactant.

Rhodafac RS-610 S-25, available from Solvay, is a sodium salt of polyethylene glycol monotridecyl ether phosphate and used as a surfactant.

Ammonia persulfate (APS), tert-Butyl hydroperoxide (t-BHP), and hydrogen peroxide (H₂O₂), all available from Shanghai Chemical Reagent Co., Ltd., are used as initiators.

Acrylamide (AM, 40% active), vinyl imidazole (VI), isoascorbic Acid (IAA) used as an activator, ferrous sulfate (FeSO₄) and tetrasodium ethylenediaminetetraacetate tetrahydrate (EDTA) used as promoters, and sodium carbonate (Na₂CO₃) and ammonia used as neutralizers, silver nitrate (AgNO₃), sodium pyrithione (41% active), and zinc pyrithione (37% active) are all available from Shanghai Chemical Reagent Co., Ltd.

AMP-95 is aminomethyl propanol (2-amino-2-methyl-1-propanol) available from Angus.

The following standard analytical equipment and methods are used in the Examples.

### Coagulum Content

Weigh a 325 mesh (44 micrometers (μm)) screen on an analytical balance and record the weight of the screen to 4 decimal places, denoted as “W1”. Fix the screen between plastic rings in a screen apparatus. Weigh 200 grams (g) of an aqueous composition into a container. Pour the aqueous dispersion through the screen. Rinse the container until it is clean and pour the water through the screen. Remove the screen from the plastic rings and place the screen in an oven at 150° C. for 5±1 minutes. Remove the screen from the oven, allow it to cool down for a minute, and then weigh the screen on the analytical balance and record the weight to 4 decimal places, denoted as “W2”. Then the dry coagulum content in part per million (ppm) is calculated by (W2−W1)*5000. The acceptable dry coagulum content is 500 ppm or less, by weight based on weight of the aqueous composition. The lower the coagulum content, the more stable polymerization process in preparing the aqueous composition.

### Coloration Stability Test

Add 100 mL a sample (“unheated sample”) into a 150 mL heat-stable plastic container and place the container into an oven at 50° C. for 10 days. The resulting heated sample was taken out from the oven for evaluation. By comparing the appearance between the heated and unheated samples when observed by the naked eye, the appearance of the heated samples is visually rated using a scale of 5 to 0:

5—no visible change; 4—slight yellowing; 3—obvious yellowing; 2—slight blue or dark; 1—obvious blue or dark; 0—heavy discoloration. The rating of 3 or above is acceptable.

### Antibacterial Activity Test of Antimicrobial Composition

An antimicrobial composition sample (“test sample”) was applied onto a plastic chart with 100 micrometers (μm) film applicator. A blank plastic chart was used as an untreated control sample.

Modified JIS Z 2801 (Antimicrobial products—Test for antimicrobial activity and efficacy) was followed for determining antimicrobial activities of samples against Escherichia coli (Strain number ATCC 8739 from American Type Culture Collection) in 24 hours at 25° C. and 90% relative humidity (RH). The suspension of microorganism was diluted in a nutritive broth at 106 Colony Forming Unit per milliliter (CFU/ml). Surfaces of the control and test samples were inoculated with the diluted microbial suspension (0.3 mL), and then covered with a thin, sterile film to ensure the diluted microbial suspension close contact with the sample surfaces. Microbial concentrations on the control sample and test sample surfaces were determined at “time zero” by elution followed by dilution and plating, denoted as “V_{0-control}” and “V₀₋ₜₑₛₜ”, respectively. After the suspension of microorganism contacted with the sample surfaces, the covered control sample and test sample were allowed to incubate undisturbed at 25° C. and 90% RH for 24 hours. After incubation, residual microbial concentrations on the test sample (“V_{Test}”) and control sample (“V_{Control}”) were determined by colony count (using diluted plates and dilution ratios).

The antimicrobial activity is calculated as logarithm reduction of colony count in the test sample comparing with the control sample as below:

$$Antimicrobial activity = log [ ( {V}_{Control} / {V}_{0 - c o n trol} ) / ( {V}_{Test} / {V}_{0 - test} ) ]$$

The higher value of the antimicrobial activity indicates the higher antimicrobial efficacy of the test film. The acceptable antimicrobial activity is 2.0 or higher, indicating 99% bacteria can be killed.

### IE 1 Synthesis of Antimicrobial Composition

Firstly, a monomer emulsion 1 #(ME1) was prepared by mixing deionized (DI) water (292 g), AM (18.76 g, 40%), AA (24.26 g), BA (618.47 g), MMA (705.34 g), and RS-610 S25 surfactant (75 g, 25%). A monomer mix 2 #(MM2) was prepared by mixing BA (120.68 g), n-DDM (2.55 g), and VI (30.32 g).

Secondly, in a one-gallon vessel equipped with a reflux condenser and a stirrer, DI water (920 g) was added at an agitation rate of 130 revolutions per minute (rpm). Meanwhile, the temperature of the reaction vessel was raised to 91° C. Then FES-32 surfactant (9.53 g, 31%) and a buffer solution of sodium carbonate (Na₂CO₃) (3.02 g in 35 g DI water) was introduced into the reaction vessel.

Thirdly, the ME1 (82.4 g) and an initiator solution of APS (3.01 g in 33 g DI water) were injected into the reaction vessel. The reaction mixture was held at a temperature between 80 and 95° C. for 5 minutes (min). Thereafter, the remainder of ME1 was added into the reaction vessel over the span of 90 min. The process temperature was 84° C.-86° C. After completing the feed of ME1, 28 g of ammonia (25%-28%) to the reaction vessel was added to adjust the pH value of the contents of the reaction vessel to around 9.2 (hereinafter “in-process neutralization step”). Then a promoter solution of 0.0194 g of ferrous sulfate and 0.1241 g of EDTA sodium salt in 3.70 g of DI water was added into vessel. After that, the MM2 was added into the reaction vessel over the span of 20 min. During the addition of MM2, another shot of a reductant solution (0.50 g IAA in 30 g DI water) and an initiator solution of t-BHP (0.70 g 70% aqueous solution in 29.30 g DI water) were co-fed into the reaction vessel over the span of 20 min. After the completion of the MM2, start to cool the contents of the reaction vessel to room temperature. As the reaction mixture was cooling down, a reductant solution (0.84 g IAA in 40.75 g DI water), and an initiator solution of t-BHP and H₂O₂(0.91 g 70% aqueous solution t-BHP, and 0.40 g 35% aqueous solution H₂O₂ in 40 g DI water) were injected into the reaction vessel when the temperature had dropped to 65° C. Then a H₂O₂ solution (2.69 g 35% aqueous solution H₂O₂ in 5.56 g H₂O) was added into the reaction vessel when the temperature was over 50° C. Then a silver nitrate solution of 2.92 g of AgNO₃ in 58 g of H₂O was fed to the reaction vessel with the span of 30 min when temperature was under 45° C. Thus, IE 1 antimicrobial composition was obtained with a silver content of 1200 ppm by weight based on dry weight of the resulting multistage polymer.

### IEs 2-11 and CEs A-J and L-O

These antimicrobial compositions were synthesized according to the same procedure as Ex 1 except stage ratios, formulations for ME1 and MM, and silver contents are given in Table 1, and neutralization described below:

For IE3, the pH value in the in-process neutralization step (i.e., the neutralizer was added before the second stage of the multistage polymerization) was adjusted to 9.2 before the second stage of multistage polymerization.

For CE-A, AMP-95 was used in the in-process neutralization step to adjust pH to 8.5.

For CE-B, the in-process neutralization step was omitted while ammonia was added after completing the second-stage polymerization to adjust the pH value of the resulting dispersion to 8.5.

For IEs 2 and 4-11 and CEs C-J and L-O, ammonia was added in the in-process neutralization step in an amount to adjust the pH value to 8.5.

### IEs 12 to 15

IE 12, IE 13, IE 14, and IE 15 were prepared by post adding sodium pyrithione (41% active) or zinc pyrithione (37% active) into IE 1, in an amount given in the below table, where percent refers to by dry weight of sodium pyrithione or zinc pyrithione, based on the weight of the antimicrobial composition of IE1.

| | |
|---|---|
| IE 12 | 0.18% Zinc pyrithione |
| IE 13 | 1.07% Zinc pyrithione |
| IE 14 | 0.17% Sodium pyrithione |
| IE 15 | 1.01% Sodium pyrithione |

### CE-K

Firstly, a monomer emulsion (ME) was prepared by mixing DI water (292 g), AM (18.76 g, 40%), AA (24.26 g), BA (739.15 g), MMA (705.34 g), n-DDM (2.55 g), VI (30.32 g), and RS-610 S25 surfactant (75 g, 25%).

Secondly, in a one-gallon vessel equipped with a reflux condenser and a stirrer, DI water (920 g) was added at an agitation rate of 130 revolutions per minute (rpm). Meanwhile, the temperature of the reaction vessel was raised to 91° C. Then FES-32 surfactant (9.53 g, 31%) and a buffer solution of sodium carbonate (Na₂CO₃) (3.02 g in 35 g DI water) were introduced into the reaction vessel.

Thirdly, ME (82.4 g) and an initiator solution of APS (3.01 g in 33 g DI water) were injected into the reaction vessel. The reaction mixture was held at a temperature between 8° and 95° C. for 5 min. Thereafter, the remainder of ME was added into the reaction vessel over the span of 110 min. The process temperature was 84° C.-86° C. After completing the feed of ME, start to cool the contents of the reaction vessel to room temperature. As the reaction mixture was cooling down, a promoter solution of 0.0194 g of ferrous sulfate and 0.1241 g of EDTA sodium salt in 3.70 g of DI water, a reductant solution (0.84 g IAA in 40.75 g DI water), and an initiator solution of t-BHP and H₂O₂(0.91 g 70% aqueous solution t-BHP, and 0.40 g 35% aqueous solution H₂O₂ in 40 g DI water) were injected into the reaction vessel when the temperature had dropped to 65° C. A large amount of coagulum was observed. Then a H₂O₂ solution (2.69 g 35% aqueous solution H₂O₂ in 5.56 g H₂O) was added into the reaction vessel when the temperature was over 50° C. After that, 28 g of ammonia (25%-28%) was added to the reaction vessel to adjust the pH value of the contents of the reaction vessel to around 9.2. Then a silver nitrate solution of 2.92 g of AgNO3 in 58 g of H2O was fed to the reaction vessel with the span of 30 min when temperature was under 45° C. Thus, CE-K was obtained with a silver content of 1200 ppm by weight based on dry weight of the resulting polymer.

The obtained compositions (solids contents between 44%-48%) were characterized and results of properties are shown in Table 2. As shown in Table 2, IEs 1-15 compositions all met both requirements for process stability (dry coagulum content<500 ppm) and coloration stability upon exposure to heat (rating of 3 or higher). IE 1 and IE 9 were also evaluated for antibacterial properties, and both showed antibacterial activity of 5.6.

In contrast, CE-A through CE-O failed one or both of the requirements. CE-B didn't include the neutralization step between two stages, the coagulum content was too high to be accepted. Comparing CE-C (MMP), CE-F (BMP), and CE-G (1-Butanethiol) with IE 1 (n-DDM), IE 4 (1-Octanethiol), and IE 5 (1-Hexanethiol), it indicates that the use of chain transfer agents could help in process stability, but only polymer dispersions prepared in the presence of specific long chain alkyl thiols (with the alkyl chain containing six or more carbon atoms) showed acceptable coloration stability.

As compared to IEs 1 and 2, CE-D and CE-H comprising the second-stage polymer with molecular weights of lower than 6500 g/mol resulted in poorer coloration stability upon exposure to heat.

CE-E and CE-J comprising multistage polymers at weight ratios of the first-stage polymer to the second-stage polymer of 70:30 provided poorer discoloration stability upon exposure to heat as compared to IEs 1 and 3.

CE-K coagulated during the one-stage polymerization process.

The multistage polymers prepared by using VI in the 2^{nd} stage while no chain transfer agent, using VI in the 1^{st} stage only and n-DDM in the 2^{nd} stage (CE-I) or in both stages (CE-L); or using VI in the 2^{nd} stage but n-DDM in the 1^{st} stage (CE-M) all failed one or both requirements for process stability and coloration stability, as compared to IE 1 using both VI and n-DDM in the 2^{nd} stage of polymerization for preparing the multistage polymer.

CE-N composition with a mole ratio (VI:Ag) of 3.18:1 showed poorer coloration stability upon exposure to heat, as compared to IE 1 and IE 8 both with mole ratios (VI:Ag) of higher than 4.

CE-A multistage polymer that was prepared by using VI in both stages at a concentration of structural units of VI in the first-stage polymer of 1.25% by weight based on the weight of the first-stage polymer, showed poor process stability as indicated by 914 ppm of coagulum (grits) formed.

TABLE 1
Antimicrobial Composition

| | Polymer Composition | | | | ⁵Silver |
|---|---|---|---|---|---|
| | ¹Stage | | | ⁴Particle | content, |
| Ex | ratio | ²ME1, % | ³MM2, % | size, nm | ppm |
| IE 1 | 80:20 | 38.75% BA/58.625% MMA/2% AA/0.625% AM | 90% BA/10% VI//1.70% n-DDM | 131 | 1200 |
| IE 2 | 80:20 | 38.75% BA/58.625% MMA/2% AA/0.625% AM | 90% BA/10% VI//0.85% n-DDM | 122 | 1200 |
| IE 3 | 90:10 | 45.56% BA/52.11% MMA/1.78% AA/0.55% AM | 80% BA/20% VI//1.70% n-DDM | 118 | 1200 |
| IE 4 | 80:20 | 38.75% BA/58.625% MMA/2% AA/0.625% AM | 90% BA/10% VI//1.20% | 131 | 1200 |
| | | | 1-Octanethiol | | |
| CE-A | 80:20 | 38.75% BA/58.625% MMA/2% AA/0.625% AM | 65% BA/25EA/10% VI | 130 | N/A |
| CE-B | 80:20 | 38.75% BA/58.625% MMA/2% AA/0.625% AM | 65% BA/25EA/10% VI//1% MMP | 136 | N/A |
| CE-C | 80:20 | 38.75% BA/58.625% MMA/2% AA/0.625% AM | 90% BA/10% VI//1% MMP | 132 | 1200 |
| CE-D | 80:20 | 38.75% BA/58.625% MMA/2% AA/0.625% AM | 90% BA/10% VI//3.40% n-DDM | 122 | 1200 |
| CE-E | 70:30 | 30% BA/67% MMA/2.29% AA/0.71% AM | 93.33% BA/6.67% VI//1.70% n-DDM | 124 | 1200 |
| CE-F | 80:20 | 38.75% BA/58.625% MMA/2% AA/0.625% AM | 90% BA/10% VI//1.35% BMP | 130 | 1200 |
| CE-G | 80:20 | 38.75% BA/58.625% MMA/2% AA/0.625% AM | 90% BA/10% VI//0.75%1-Butanethiol | 122 | 1200 |
| IE 5 | 80:20 | 38.75% BA/58.625% MMA/2% AA/0.625% AM | 90% BA/10% VI//1%1-Hexanethiol | 121 | 1200 |
| CE-H | 80:20 | 38.75% BA/58.625% MMA/2% AA/0.625% AM | 90% BA/10% VI//2.40%1-Octanethiol | 123 | 1200 |
| CE-I | 80:20 | 33.75% BA/58.625% MMA/2% AA/0.625% AM/ | 100% BA//1.70% n-DDM | N/A | N/A |
| | | 5% VI | | | |
| CE-J | 70:30 | 30% BA/67% MMA/2.29% AA/0.71% AM | 83.33% BA/16.67% VI//1.70% n-DDM | 130 | 3000 |
| IE 6 | 75:25 | 34.67% BA/62.53% MMA/2.13% AA/0.67% AM | 92% BA/8% VI//1.70% n-DDM | 128 | 1200 |
| IE 7 | 95:5 | 48.42% BA/49.37% MMA/1.68% AA/0.53% AM | 60% BA/40% VI//1.70% n-DDM | 120 | 1200 |
| CE-K | One-stage process: 49% BA/46.9% MMA/1.6% AA/0.5% AM/2% VI//1.70% n-DDM, by weight | | | N/A | 1200 |
| | based on total monomer weight | | | | |
| CE-L | 80:20 | 33.75% BA/58.625% MMA/2% AA/0.625% AM/ | 100% BA//1.70% n-DDM | 131 | 1200 |
| | | 5% VI//1.70% n-DDM | | | |
| CE-M | 80:20 | 38.75% BA/58.625% MMA/2% AA/0.625% AM// | 90% BA/10% VI | 124 | 1200 |
| | | 1.70% n-DDM | | | |
| IE 8 | 80:20 | 38.75% BA/58.625% MMA/2% AA/0.625% AM | 90% BA/10% VI//1.70% n-DDM | 131 | 4216 |
| CE-N | 80:20 | 38.75% BA/58.625% MMA/2% AA/0.625% AM | 90% BA/10% VI//1.70% n-DDM | 131 | 6310 |
| IE 9 | 80:20 | 38.75% BA/58.625% MMA/2% AA/0.625% AM | 75% BA/25% VI//1.70% n-DDM | 131 | 2865 |
| IE 10 | 80:20 | 38.75% BA/58.625% MMA/2% AA/0.625% AM | 96.25% BA/3.75% VI//1.70% n-DDM | 125 | 453 |
| IE 11 | 80:20 | 38.75% BA/58% MMA/2% AA/0.625% AM/0.62 | 90% BA/10% VI//1.70% n-DDM | 143 | 1461 |
| | | 5% VI | | | |
| CE-O | 80:20 | 38.75% BA/57.375% MMA/2% AA/0.625% AM/ | 90% BA/10% VI//1.70% n-DDM | 178 | 1775 |
| | | 1.25% VI | | | |
| IE 12 | 80:20 | 38.75% BA/58.625% MMA/2% AA/0.625% AM | 90% BA/10% VI//1.70% n-DDM | 131 | 1200 |
| IE 13 | 80:20 | 38.75% BA/58.625% MMA/2% AA/0.625% AM | 90% BA/10% VI//1.70% n-DDM | 131 | 1200 |
| IE 14 | 80:20 | 38.75% BA/58.625% MMA/2% AA/0.625% AM | 90% BA/10% VI//1.70% n-DDM | 131 | 1200 |
| IE 15 | 80:20 | 38.75% BA/58.625% MMA/2% AA/0.625% AM | 90% BA/10% VI//1.70% n-DDM | 131 | 1200 |

¹Stage ratio refers to the weight ratio of total monomers in MEI to total monomers in MM2;
²ME1: % by weight percentage relative to the total weight of monomers in ME1;
³MM2: % by weight percentage relative to the total weight of monomers in MM2;
⁴Particle size was measured by Brookhaven BI-90 Plus Particle Size Analyzer;
⁵Silver content refers to ppm of silver ion by weight based on the dry weight of the multistage polymer.

TABLE 2
Characterization and Properties of Antimicrobial Composition

| | Characterization | | | | |
|---|---|---|---|---|---|
| | ⁶VI:Ag | ⁷Mn of 2^{nd} | ⁸Coagulum | | ⁹Coloration |
| Ex | mole ratio | polymer | content | | stability |
| IE 1 | 19.13 | 12084 | 103 | ppm | 4 |
| IE 2 | 19.13 | 23967 | 327 | ppm | 4 |
| IE 3 | 19.13 | 12084 | 2 | ppm | 5 |
| IE 4 | 19.13 | 12113 | 88 | ppm | 4 |
| CE-A | N/A | | 924 | ppm | N/A |
| CE-B | N/A | 12120 | >3300 | ppm | N/A |
| CE-C | 19.13 | 12120 | 27 | ppm | 0 |
| CE-D | 19.13 | 6143 | 432 | ppm | 2 |
| CE-E | 19.13 | 12084 | 48 | ppm | 1 |
| CE-F | 19.13 | 12100 | 176 | ppm | 2 |
| CE-G | 19.13 | 12124 | 62 | ppm | 1 |
| IE 5 | 19.13 | 12110 | 147 | ppm | 3 |
| CE-H | 19.13 | 6246 | 34 | ppm | 2 |
| CE-I | N/A | 12330 | Coagulated during | | N/A |
| | | | polymerization | | |
| CE-J | 19.13 | 12092 | 192 | ppm | 1 |
| IE 6 | 19.13 | 12083 | 43 | ppm | 3 |
| IE 7 | 19.13 | 12046 | 112 | ppm | 5 |
| CE-K | N/A | 12092 | Coagulated during | | N/A |
| | | | polymerization | | |
| CE-L | 19.13 | 12330 | 2512 | ppm | 1 |
| CE-M | 19.13 | | 21 | ppm | 1 |
| IE 8 | 5.03:1 | 12084 | 103 | ppm | 3 |
| CE-N | 3.18:1 | 12084 | 103 | ppm | 1 |
| IE 9 | 19.13 | 12092 | 396 | ppm | 4 |
| IE 10 | 19.13 | 12092 | 101 | ppm | 3 |
| IE 11 | 19.13 | 12084 | 311 | ppm | 4 |
| CE-O | 19.13 | 12084 | 914 | ppm | 3 |
| IE 12 | 19.13 | 12084 | 103 | ppm | 4 |
| IE 13 | 19.13 | 12084 | 103 | ppm | 4.5 |
| IE 14 | 19.13 | 12084 | 103 | ppm | 4 |
| IE 15 | 19.13 | 12084 | 103 | ppm | 4 |

⁶VI:Ag mole ratio refers to the ratio of the mole of imidazole groups in the multistage polymer to mole of Ag;
⁷Mw of 2^{nd} stage polymer refers to calculated molecular weight according to the equation (I) described above;
⁸Coagulum content by weight based on the weight of aqueous dispersion as measured according to the Coagulum Content Test above;
⁹Coloration stability was measured according to the Coloration Stability Test described above.

1. An aqueous antimicrobial composition comprising:
(A) a multistage polymer comprising, by weight based on the weight of the multistage polymer, from 75% to 95% of a first-stage polymer and from 5% to 25% of a second-stage polymer;
wherein the first-stage polymer comprises:
zero to 1.0% of structural units of a monomer containing at least one heterocyclic group selected from imidazole, benzotriazole, and benzimidazole, by weight based on the weight of the first-stage polymer;
structural units of a monoethylenically unsaturated functional monomer carrying at least one functional group selected from a carboxyl, carboxylic anhydride, sulfonic acid, amide, sulfonate, phosphoric acid, phosphonate, phosphate, or hydroxyl group, a salt thereof, or combinations thereof; and
structural units of a monoethylenically unsaturated nonionic monomer;
wherein the second-stage polymer has a molecular weight of 8000 to 30000 grams per mole and residues of an alkyl thiol with a C₆-C₂₄ alkyl and comprises:
structural units of a monomer containing at least one heterocyclic group selected from imidazole, benzotriazole, and benzimidazole; and
structural units of an alkyl acrylate;
wherein structural units of the monomer containing at least one heterocyclic group in the multistage polymer are present at a total concentration of 0.5% to 8%, by weight based on the weight of the multistage polymer; and
(B) 1 to 10000 parts per million, by weight based on the weight of the multistage polymer, of a silver;
wherein the mole ratio of heterocyclic groups in the multistage polymer to the silver is greater than 4; and
wherein the aqueous antimicrobial composition comprises up to 500 parts per million of coagulum, by weight based on the weight of the aqueous antimicrobial composition.

2. The aqueous antimicrobial composition of claim 1, wherein the alkyl thiol is selected from the group consisting of n-dodecyl mercaptan, octanethiol, hexanethiol, and mixtures thereof.

3. The aqueous antimicrobial composition of claim 1, wherein the alkyl acrylate is selected from the group consisting of butyl acrylate, ethyl acrylate, and mixtures thereof.

4. The aqueous antimicrobial composition of claim 1, wherein the second-stage polymer comprises, by weight based on the weight of the second-stage polymer, from 0.6% to 80% of structural units of the monomer containing at least one heterocyclic group.

5. The aqueous antimicrobial composition of claim 1, wherein the first-stage polymer comprises from zero to 0.65% of structural units of the monomer containing at least one heterocyclic group; from 0.5% to 10% of structural units of the monoethylenically unsaturated functional monomer, the salt thereof, or combinations thereof; and from 90% to 99.5% of structural units of a C₁-C₄ alkyl (meth)acrylate, by weight based on the weight of the first-stage polymer.

6. The aqueous antimicrobial composition of claim 1, wherein the monomer containing at least one heterocyclic group is 1-vinyl imidazole.

7. The aqueous antimicrobial composition of claim 1, wherein the second-stage polymer comprises from 3% to 50% of structural units of 1-vinyl imidazole and from 50% to 97% of structural units of butyl acrylate, ethyl acrylate, or mixtures thereof, by weight based on the weight of the second-stage polymer.

8. The aqueous antimicrobial composition of claim 1, wherein the total concentration of structural units of the monomer containing at least one imidazole group in the multistage polymer is 0.75% to 5%, by weight based on the weight of the multistage polymer.

9. The aqueous antimicrobial composition of claim 1, further comprising, by weight based on the weight of the aqueous antimicrobial composition, from 0.01% to 1.5% of pyrithione, a pyrithione metal complex, or mixtures thereof.

10. A method of preparing the aqueous antimicrobial composition of claim 1, comprising: admixing the multistage polymer with the silver; wherein the multistage polymer comprising the first-stage polymer and the second-stage polymer is prepared by a multistage free-radical polymerization process comprising:
(i) forming the first-stage polymer by free-radical polymerization of a first monomer mixture, followed by neutralizing the first-stage polymer to a pH value of greater than 7.5; thereby obtaining the neutralized first-stage polymer; and
(ii) preparing the second-stage polymer by free-radical polymerization of a second monomer mixture in the presence of the neutralized first stage-polymer obtained from step (i) above;
wherein the first monomer mixture comprises, by weight based on the total weight of monomers in the first monomer mixture, zero to 1.0% of a monomer containing at least one heterocyclic group selected from imidazole, benzotriazole, and benzimidazole; a monoethylenically unsaturated functional monomer carrying at least one functional group selected from a carboxyl, carboxylic anhydride, sulfonic acid, amide, sulfonate, phosphoric acid, phosphonate, phosphate, or hydroxyl group, a salt thereof, or combinations thereof; and a monoethylenically unsaturated nonionic monomer;
wherein the second monomer mixture comprises, by weight based on the total weight of monomers in the second monomer mixture, a monomer containing at least one heterocyclic group selected from imidazole, benzotriazole, and benzimidazole; an alkyl acrylate; and an alkyl thiol with a C₆-C₂₄ alkyl; and
wherein the total concentration of the monomer containing at least one heterocyclic group for preparing the multistage polymer is 0.5% to 8%, by weight based on the total weight of monomers in the first and second monomer mixtures.

11. A coating composition comprising the aqueous antimicrobial composition of claim 1 and a pigment.
